(19) United States
(12) Patent Application Publication
(10) Pub. No.: US 2017/0040608 A1
(43) Pub. Date: Feb. 9, 2017

(54) BATTERY POSITIVE ELECTRODE MATERIAL AND LITHIUM ION BATTERY

(71) Applicant: Panasonic Intellectual Property Management Co., Ltd., Osaka (JP)

(72) Inventors: KAZUKO ASANO, Osaka (JP); KENSUKE NAKURA, Osaka (JP)

(21) Appl. No.: 15/215,795

(22) Filed: Jul. 21, 2016

(30) Foreign Application Priority Data
Aug. 3, 2015 (JP) 2015-153029

(51) Int. Cl. H01M 4/525; H01M 4/62; H01M 4/66; H01M 2/16; H01M 10/0525; H01M 10/0569; H01M 10/0568; H01M 4/131; H01M 4/38

(52) U.S. Cl. CPC H01M 4/525; H01M 4/131; H01M 4/623; H01M 4/625; H01M 4/661; H01M 4/382; H01M 10/0525; H01M 10/0569; H01M 10/0568; H01M 2/1686; H01M 2/1653; H01M 2004/028

(57) ABSTRACT

A battery positive electrode material of the present disclosure is a battery positive electrode material containing a positive electrode active substance represented by the following composition formula (2). According to this battery positive electrode material, an increase in capacity of a lithium ion battery can be realized. In addition, a lithium ion battery of the present disclosure is a lithium ion battery including a positive electrode, a negative electrode, and an electrolyte, the positive electrode including a battery positive electrode material which contains the positive electrode active substance described above. Accordingly, a lithium ion battery having a high capacity can be realized.

Li_{α}Mo_{β}Fe_{γ}O_{z}, Formula (2)

### BACKGROUND

1. Technical Field

The present disclosure relates to a lithium ion battery and a positive electrode material thereof.

2. Description of the Related Art

In Japanese Unexamined Patent Application Publication No. 55-136131, a positive electrode material represented by LiCoO₂ for a lithium ion battery has been disclosed.

### SUMMARY

In a related technique, an increase in capacity of a lithium ion battery has been desired.

In one general aspect, the techniques disclosed here feature a battery positive electrode material containing a positive electrode active substance represented by the following composition formula (2).

Li_{α}Mo_{β}Fe_{γ}O_{z} Formula (2)

In the above formula (2), 1<α<4, 0<β<1, 0<γ<1, and 2<z<5 hold.

According to the present disclosure, the increase in capacity of a lithium ion battery can be realized.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a view showing a schematic structure of a battery of Embodiment 1;

FIG. 2 is a graph showing the results of an X-ray diffraction measurement;

FIG. 3 is a graph showing an initial discharge capacity; and

FIG. 4 is a graph showing the results of an X-ray diffraction measurement.

### DETAILED DESCRIPTION

Hereinafter, an embodiment will be described with reference to the drawings.

### Embodiment 1

A battery positive electrode material of Embodiment 1 contains a positive electrode active substance which is a composite material of Li₄MoO₅ and LiFeO₂.

That is, the composite material is represented by the following composition formula (1).

(1−X)Li₄MoO₅—XLiFeO₂ Formula (1)

In the above formula (1), 0<X<1 holds.

In other words, the battery positive electrode material of Embodiment 1 contains a positive electrode active substance represented by the following composition formula (2).

Li_{α}Mo_{β}Fe_{γ}O_{z} Formula (2)

In the above formula (2),
1<α<4,
0<β<1,
0<γ<1, and
2<z<5 hold.

According to the composition described above, the increase in capacity of a lithium ion battery can be realized.

In addition, a lithium ion battery of Embodiment 1 includes a positive electrode containing the above battery positive electrode material, a negative electrode, and an electrolyte.

According to the composition described above, a high-capacity lithium ion battery can be realized.

In a related positive electrode material LiMeO₂ (Li/Me=1 (Me=Co, Ni, or the like), with respect to one metal element Me in a unit structure, the number of Li elements to be contained is 1. Hence, from a theoretical point of view, a 1 electron reaction (Li/Me=1.0) is only performed. A crystal structure of the above related positive electrode material is a laminate structure in which at least one Li layer formed only from Li and at least one Me layer formed only from a metal are laminated to each other. Hence, in charging, Li is released from the Li layer, and a void is generated between the layers. Accordingly, as the charge reaction is advanced, the crystal structure is liable to be unstable. As a result, the inherent electrochemical capacity of the material may not be sufficiently extracted. For example, in the case of LiCoO₂, an electrochemical capacity corresponding to that of up to Li/Co=0.5 may only be used, and hence, the actual capacity is limited to up to 120 mAh/g.

On the other hand, the positive electrode material of Embodiment 1 contains more than one Li element 1 with respect to one metal element in the unit structure (Li/Me>1, (Me=Mo and/or Fe)). Hence, a larger amount of Li may be incorporated in the reaction as compared to that of the related positive electrode material. As a result, a high capacity can be obtained.

As described above, since containing the positive electrode active substance which is the composite material of Li₄MoO₅ and LiFeO₂, the positive electrode material of Embodiment 1 can realize a lithium ion battery having a high energy density.

Next, a charge/discharge reaction mechanism conceived by the present inventor will be described.

When (1−X)Li₄MoO₅—XLiFeO₂ is used as a positive electrode active substance, from a theoretical point of view, with respect to one transition metal element, at least one Li element and at least one electron may be used. For example, when X=0.7 holds, a theoretical capacity of a 1 electron reaction is 305 mAh/g, and a theoretical capacity of a 1.3 electron reaction (in the case in which all Li elements in the structure are allowed to react) is 400 mAh/g. In charging, an oxidation reaction from trivalent Fe to tetravalent Fe occurs. In addition, in charging, an oxidation reaction with oxygen occurs. In addition, in discharging, a reduction reaction from tetravalent Fe to trivalent Fe occurs. Furthermore, in discharging, a reduction reaction generating a plurality of valence changes from hexavalent Mo to tetravalent Mo also occurs. A reduction reaction of oxygen occurs.

By the reactions as described above, a large amount of Li as compared to that of the related positive electrode material can be inserted and released.

In addition, in Embodiment 1, the composite material may also satisfy 0.3≦X≦0.9 in the above composition formula (1).

In other words, in Embodiment 1, the positive electrode active substance may also satisfy in the above composition formula (2),

1.3≦α≦3.1,
0.1≦β≦0.7,
0.3≦γ≦0.9, and
2.3≦z≦4.1.

According to the composition described above, a lithium ion battery having a higher capacity can be realized.

In addition, in Embodiment 1, the positive electrode active substance may also satisfy z=α+β+γ in the above composition formula (2).

According to the composition described above, a lithium ion battery having a higher capacity can be realized.

In addition, in Embodiment 1, the half width of a diffraction peak of the (200) plane of the positive electrode active substance at 2θ by a powder X-ray diffraction (XRD) may also be 0.29°.

According to the composition described above, a lithium ion battery having a higher capacity can be realized.

In addition, in Embodiment 1, the crystal structure of the positive electrode active substance may also be a rock salt type.

According to the composition described above, since having a rock salt type structure, in charging, for example, even when Li in an amount corresponding to that of Li/Me=1.0 or more is released, the structure is not likely to collapse. Hence, a lithium ion battery having a higher capacity can be realized.

### (Method for Forming Positive Electrode Active Substance)

Particles of the positive electrode active substance of Embodiment 1 may be formed, for example, by the following method.

A raw material mixture is obtained by mixing particles of a lithium compound, particles of an iron compound, and particles of a molybdenum compound. In this case, for example, when the mixing amounts of the respective compounds are adjusted, the X value of the composition formula (1) and the α, β, γ, and z values of the composition formula (2) can be adjusted. That is, for example, when the respective raw materials are weighed in accordance with the stoichiometric ratio thereof, the X value of the composition formula (1) and the α, β, γ, and z values of the composition formula (2) can be adjusted.

As the lithium compound, for example, lithium hydroxide, lithium carbonate, lithium oxide, lithium nitrate, or lithium peroxide may be mentioned. As the iron compound, for example, iron oxide or iron hydroxide may be mentioned. As the molybdenum compound, for example, various types of molybdenum oxides or ammonium molybdate may be mentioned. However, the lithium source, the iron source, and the molybdenum source are not limited to those mentioned above, and various raw materials may also be used.

A step of mixing particles of the lithium compound, particles of the iron compound, and particles of the molybdenum compound may be performed by either a dry method or a wet method. In the mixing step, a mixing machine, such as a ball mill, may be used.

The raw material mixture thus obtained is fired, for example, in an oxygen atmosphere. Accordingly, the positive electrode active substance of Embodiment 1 can be obtained. The firing step may be performed, for example, at a temperature of 300° C. to 900° C. for 1 to 24 hours. Alternatively, when the raw material mixture thus obtained is processed by a mechanochemical treatment (such as ball milling), the positive electrode active substance of Embodiment 1 may also be obtained. The ball milling step may be performed at 400 to 600 rpm for 5 to 50 hours.

### (Structure of Battery)

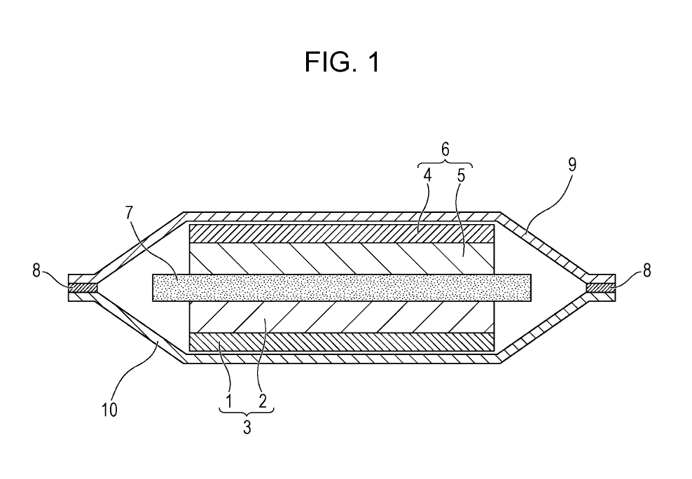

FIG. 1 is a view showing a schematic structure of a battery of Embodiment 1.

In the structural example shown in FIG. 1, a positive electrode 3 includes a positive electrode collector 1 and a positive electrode mixture layer 2 formed thereon and containing a positive electrode active substance. A negative electrode 6 includes a negative electrode collector 4 and a negative electrode mixture layer 5 formed thereon and containing a negative electrode active substance. The positive electrode 3 and the negative electrode 6 are arranged with a separator 7 interposed therebetween so that the positive electrode mixture layer 2 and the negative electrode mixture layer 5 face each other. Those electrode groups are covered with a negative electrode side package 9 and a positive electrode side package 10. In addition, the battery shown in FIG. 1 includes a gasket 8.

In addition, the shape of the battery is not particularly limited, and a battery having a coin shape, a cylindrical shape, a square shape, or the like may be formed.

A positive electrode is formed, for example, of a positive electrode collector and a positive electrode mixture carried thereon. The positive electrode mixture may contain, besides a positive electrode active substance, a binding agent, an electrically conductive agent, and/or the like. The positive electrode may also be formed, for example, in such a way that after a positive electrode mixture formed of an arbitrary component and a positive electrode active substance is mixed with a liquid component to form a positive electrode mixture slurry, the slurry thus obtained is applied on a positive electrode collector and then dried.

A negative electrode is formed, for example, of a negative electrode collector and a negative electrode mixture carried thereon. The negative electrode mixture may contain, besides a negative electrode active substance, a binding agent and/or the like. The negative electrode may also be formed, for example, in such a way that after a negative electrode mixture formed of an arbitrary component and a negative electrode active substance is mixed with a liquid component to form a negative electrode mixture slurry, the slurry thus obtained is applied on a negative electrode collector and then dried.

As the negative electrode active substance, for example, there may be used a metal, metal fibers, a carbon material, an oxide, a nitride, a tin compound, a silicon compound, and various alloy materials. As the carbon material, for example, various types of natural graphite, coke, graphitizing carbon, carbon fibers, spherical carbon, various types of artificial graphite, and amorphous carbon may be used. In addition, a single element, such as silicon (Si) or tin (Sn), or a silicon compound or a tin compound, each of which is an alloy, a compound, a solid solution, or the like, has a high capacity density. For example, as the silicon compound, for example, there may be used SiOₓ (0.05<x<1.95), or an alloy, a compound, or a solid solution, each of which is obtained by partially substituting Si in the above compound by at least one element selected from the group consisting of B, Mg, Ni, Ti, Mo, Co, Ca, Cr, Cu, Fe, Mn, Nb, Ta, V, W, Zn, C, N, and Sn. As the tin compound, for example, Ni₂Sn₄, Mg₂Sn, SnOₓ (0<x<2), SnO₂, or SnSiO₃ may be used. As the negative electrode active substance, those compounds may be used alone, or at least two types thereof may be used in combination.

As the binding agent for the positive electrode or the negative electrode, for example, there may be used a PVDF, a polytetrafluoroethylene, a polyethylene, a polypropylene, an aramid resin, a polyamide, a polyimide, a poly(amide imide), a polyacrylonitrile, a poly(acrylic acid), a poly(methyl acrylate), a poly(ethyl acrylate), a poly(hexyl acrylate), a poly(methacrylic acid), a poly(methyl methacrylate), a poly(ethyl methacrylate), a poly(hexyl methacrylate), a poly(vinyl acetate), a poly(vinyl pyrrolidone), a polyether, a poly(ether sulfone), a hexafluoropolypropylene, a styrene-butadiene rubber, or a carboxymethyl cellulose. In addition, a copolymer formed from at least two types of materials selected from the group consisting of tetrafluoroethylene, hexafluoropropylene, a perfluoroalkyl vinyl ether, vinylidene fluoride, chlorotrifluoroethylene, ethylene, propylene, pentafluoropropylene, fluoromethyl vinyl ether, acrylic acid, and hexadiene. In addition, at least two types selected from those polymers mentioned above may be used by mixing.

As the electrically conductive agent contained in the electrode, for example, there may be used a graphite, such as natural graphite or artificial graphite; a carbon black, such as acetylene black, ketjen black, channel black, furnace black, lamp black, or thermal black; electrically conductive fibers, such as carbon fibers or metal fibers; a fluorinated carbon; a metal powder of aluminum or the like; electrically conductive whiskers of zinc oxide or potassium titanate; an electrically conductive metal oxide such as titanium oxide: or an organic electrically conductive material such as a phenylene derivative.

The blending rates of the positive electrode active substance, the electrically conductive agent, and the binding agent may be set to 80 to 97 percent by weight, 1 to 20 percent by weight, and 1 to 10 percent by weight, respectively.

In addition, the blending rates of the negative electrode active substance and the binding agent may be set to 93 to 99 percent by weight and 1 to 10 percent by weight, respectively.

For the collector, a long electrically conductive substrate having a porous structure or a long electrically conductive substrate having a nonporous structure may be used. As a material used for the electrically conductive substrate, for the positive electrode collector, for example, stainless steel, aluminum, or titanium may be used. In addition, for the negative electrode collector, for example, stainless steel, nickel, or copper may be used. Although the thickness of each of those collectors is not particularly limited, the thickness thereof may be 1 to 500 jam. Alternatively, the thickness of the collector may also be 5 to 20 μm. When the thickness of the collector is set in the range described above, the weight reduction can be achieved while the strength of the electrode plate is maintained.

As the separator interposed between the positive electrode and the negative electrode, a fine porous thin film, a woven cloth, or a nonwoven cloth, each of which has a high ion permeability, a predetermined mechanical strength, and insulating properties, may be used. As a material for the separator, for example, a polyolefin, such as a polypropylene or a polyethylene, may be used since having excellent durability and a shutdown function. Hence, those materials are preferable in view of the safety of a nonaqueous electrolyte secondary battery. The thickness of the separator may be 10 to 300 μm or may be set to 40 μm or less. In addition, the thickness of the separator may also be set in a range of 15 to 30 jam. In addition, the thickness of the separator may also be 10 to 25 μm. Furthermore, the fine porous film may be a single layer film formed from one type of material. Alternatively, the fine porous film may be a composite film or a multilayer film, each of which is formed from at least one type of material. In addition, the porosity of the separator may be in a range of 30% to 70%. In this case, the porosity indicates a volume ratio of pore portions to the separator volume. The porosity of the separator may also be in a range of 35% to 60%.

As the nonaqueous electrolyte, a substance in the form of liquid, gel, or solid (high molecular weight solid electrolyte) may be used.

The liquid nonaqueous electrolyte (nonaqueous electrolyte solution) is obtained by dissolving an electrolyte (such as a lithium salt) in a nonaqueous solvent. In addition, the gel nonaqueous electrolyte contains a nonaqueous electrolyte and a high molecular weight material holding this nonaqueous electrolyte. As this high molecular weight material, for example, a poly(vinylidene fluoride), a polyacrylonitrile, a poly(ethylene oxide), a poly(vinyl chloride), a polyacrylate, or a poly(vinylidene fluoride-hexafluoropropylene) may be preferably used.

As the nonaqueous solvent dissolving an electrolyte, a known nonaqueous solvent may be used. Although the type of this nonaqueous solvent is not particularly limited, for example, a cyclic carbonate ester, a chain carbonate ester, or a cyclic carboxylate ester may be used. As the cyclic carbonate ester, for example, propylene carbonate (PC) or ethylene carbonate (EC) may be mentioned. As the chain carbonate ester, for example, diethyl carbonate (DEC), ethyl methyl carbonate (EMC), or dimethyl carbonate (DMC) may be mentioned. As the cyclic carboxylate ester, for example, γ-butyrolactone (GBL) or γ-valerolactone (GVL) may be mentioned. The nonaqueous solvents may be used alone, or at least two types thereof may be used in combination.

In Embodiment 1, as the nonaqueous solvent contained in a nonaqueous electrolyte solution, a fluorinated solvent may also be used. In this case, as the fluorinated solvent, at least one fluorinated solvent selected from the group consisting of fluoroethylene carbonate, methyl fluoropropionate, fluorobenzene, fluoroethyl methyl carbonate, and fluorodimethylene carbonate may be used.

When at least one of those fluorinated solvents is contained in a nonaqueous electrolyte solution, the oxidation resistance thereof is improved. Hence, even when a battery is charged at a high voltage, the battery can be stably operated.

As the electrolyte dissolved in the nonaqueous solvent, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, a lithium lower aliphatic carboxylate, LiCl, LiBr, LiI, lithium chloroborate, a borate, or an imide salt may be used. As the borate, for example, there may be mentioned lithium bis(1,2-benzenediolate(2-)-O,O′) borate, lithium bis(2,3-naphthalenediolate(2-)-O,O′) borate, lithium bis(2,2-biphenyldiolate(2-)-O,O′) borate, or lithium bis(5-fluoro-2-olate-1-benzenesulfonic acid-O,O′) borate. As the imide salt, for example, there may be mentioned lithium bis(trifluoromethanesulfonyl)imide ((CF₃SO₂)₂NLi), lithium trifluoromethanesulfonyl nonafluorobutanesulfonyl imide (LiN(CF₃SO₂)(C₄F₉SO₂)), or lithium bis(pentafluoroethanesulfonyl)imide ((C₂F₅SO₂)₂NLi). Those electrolytes may be used alone, or at least two types thereof may be used in combination.

As an additive, a material which is decomposed on the negative electrode to form a film having a high lithium ion conductivity and to improve the charge/discharge efficiency may be contained in the nonaqueous electrolyte solution. As an additive having the function as described above, for example, there may be mentioned vinylene carbonate (VC), 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate (VEC), or divinyl ethylene carbonate. Those materials may be used alone, or at least two types thereof may be used in combination. Among those mentioned above, at least one selected from the group consisting of vinylene carbonate, vinyl ethylene carbonate, and divinyl ethylene carbonate is preferable. In addition, in the compounds described above, some of the hydrogen atoms may be substituted by at least one fluorine atom. The dissolved amount of the electrolyte in the nonaqueous solvent may be in a range of 0.5 to 2 mol/L.

Furthermore, in the nonaqueous electrolyte solution, a benzene derivative which is decomposed in overcharging to form a film on the electrode and to inactivate the battery may also be contained. As the benzene derivative, for example, a compound having a phenyl group or a compound having a cyclic compound group adjacent to a phenyl group may be used. As the cyclic compound group, for example, there may be used a phenyl group, a cyclic ether group, a cyclic ester group, a cycloalkyl group, or a phenoxy group. As a particular example of the benzene derivative, cyclohexyl benzene, biphenyl, or diphenyl ether may be mentioned. Those compounds may be used alone, or at least two types thereof may be used in combination. The content of the benzene derivative may be 10 percent by volume or less of the total nonaqueous solvent.

### EXAMPLES

### Example 1

### (1) Formation of Positive Electrode Active Substance

Predetermined amounts of lithium peroxide, iron hydroxide, and molybdenum oxide were weighed in respective containers, so that a raw material mixture was obtained. That is, the raw materials were weighed and mixed together in accordance with the stoichiometric ratio thereof. The raw material mixture thus obtained was fired at 450° C. for 3 hours in an oxygen atmosphere. In Example 1, as the positive electrode active substance, (0.7)Li₄MoO₅-(0.3)LiFeO₂ was obtained in which the X value of (1−X)Li₄MoO₅—XLiFeO₂ was 0.3. That is, as the positive electrode active substance, Li_{3.1}Mo_{0.7}Fe_{0.3}O_{4.1} was obtained.

### (2) Formation of Positive Electrode Plate

With 70 parts by weight of the above positive electrode active substance, 20 parts by weight of acetylene black as an electrically conductive agent, 10 parts by weight of N-methylpyrrolidone (NMP) as a binding agent, and an appropriate amount of a poly(vinylidene fluoride) (PVDF) were mixed. Accordingly, a paste containing a positive electrode mixture was obtained. After this paste was applied on two surfaces of aluminum foil having a thickness of 20 μm, which was to be used as a collector, and was then dried, the foil was rolled. As a result, a positive electrode plate including positive electrode active substance layers and having a thickness of 60 μm was obtained. Subsequently, this positive electrode plate was punched out to form a disc having a diameter of 12.5 mm, so that a positive electrode was obtained.

### (3) Formation of Negative Electrode Plate

Lithium metal foil having a thickness of 300 μm was punched out to form a disc having a diameter of 14.0 mm, so that a negative electrode was obtained.

### (4) Preparation of Nonaqueous Electrolyte Solution

Fluoroethylene carbonate (FEC), ethylene carbonate (EC), and ethyl methyl carbonate (EMC) were mixed together at a volume ratio of 1:1:6, so that a nonaqueous solvent was obtained. In this nonaqueous solvent, LiPF₆ was dissolved to have a concentration of 1.0 mol/liter, so that a nonaqueous electrolyte solution was obtained.

### (5) Formation of Battery

A battery having the structure shown in FIG. 1 was formed. The nonaqueous electrolyte solution was impregnated into a separator (manufactured by Celgard, product No: 2320, thickness: 25 μm), and a CR2032 standard coin battery was formed in a dry box in which the dew point was controlled to −50° C. In addition, the product No. 2320 is a three-layered separator formed of a polypropylene layer, a polyethylene layer, and a polypropylene layer.

### Example 2

As the positive electrode active substance, (0.5)Li₄MoO₆-(0.5)LiFeO₂ was used in which the X value of (1−X)Li₄MoO₆—XLiFeO₂ was 0.5. That is, as the positive electrode active substance, Li_{2.6}Mo_{0.5}Fe_{0.5}O_{3.5} was used. Except that the composition ratio of this positive electrode material was changed, a battery of Example 2 was formed in a manner similar to that of Example 1.

### Example 3

As the positive electrode active substance, (0.3)Li₄MoO₆-(0.7)LiFeO₂ was used in which the X value of (1−X)Li₄MoO₆—XLiFeO₂ was 0.7. That is, as the positive electrode active substance, Li_{1.9}Mo_{0.3}Fe_{0.7}O_{2.9} was used. Except that the composition ratio of this positive electrode material was changed, a battery of Example 3 was formed in a manner similar to that of Example 1.

### Example 4

As the positive electrode active substance, (0.2)Li₄MoO₆-(0.8)LiFeO₂ was used in which the X value of (1−X)Li₄MoO₆—XLiFeO₂ was 0.8. That is, as the positive electrode active substance, Li_{1.6}Mo_{0.2}Fe_{0.8}O_{2.6} was used. Except that the composition ratio of this positive electrode material was changed, a battery of Example 4 was formed in a manner similar to that of Example 1.

### Example 5

As the positive electrode active substance, (0.1)Li₄MoO₆-(0.9)LiFeO₂ was used in which the X value of (1−X)Li₄MoO₆—XLiFeO₂ was 0.9. That is, as the positive electrode active substance, Li_{1.3}Mo_{0.1}Fe_{0.9}O_{2.3} was used. Except that the composition ratio of this positive electrode material was changed, a battery of Example 5 was formed in a manner similar to that of Example 1.

### Example 6

As the positive electrode active substance, (0.8)Li₄MoO₆-(0.2)LiFeO₂ was used in which the X value of (1−X)Li₄MoO₆—XLiFeO₂ was 0.2. That is, as the positive electrode active substance, Li_{3.4}Mo_{0.8}Fe_{0.2}O_{4.4} was used. Except that the composition ratio of this positive electrode material was changed, a battery of Example 6 was formed in a manner similar to that of Example 1.

### Comparative Example 1

As the positive electrode active substance, Li₄MoO₆ was used in which the X value of (1−X)Li₄MoO₆—XLiFeO₂ was 0. Except that the composition ratio of this positive electrode material was changed, a battery of Comparative Example 1 was formed in a manner similar to that of Example 1.

### Comparative Example 2

As the positive electrode active substance, LiFeO₂ was used in which the X value of (1−X)Li₄MoO₆—XLiFeO₂ was 1. Except that the composition ratio of this positive electrode material was changed, a battery of Comparative Example 2 was formed in a manner similar to that of Example 1.

### Comparative Example 3

As the positive electrode active substance, LiCoO₂ was used. Except that the composition of this positive electrode material was changed, a battery of Comparative Example 3 was formed in a manner similar to that of Example 1.

### (Evaluation of Each Battery)

For charging, after constant current charging at a current of 0.05 CmA was performed to an upper limit voltage of 4.8 V, charging at a constant voltage of 4.8 V was further performed to a current of 0.01 CmA.

For discharging, constant current discharging at a current of 0.05 CmA was performed to a discharge cutoff voltage of 1.5 V.

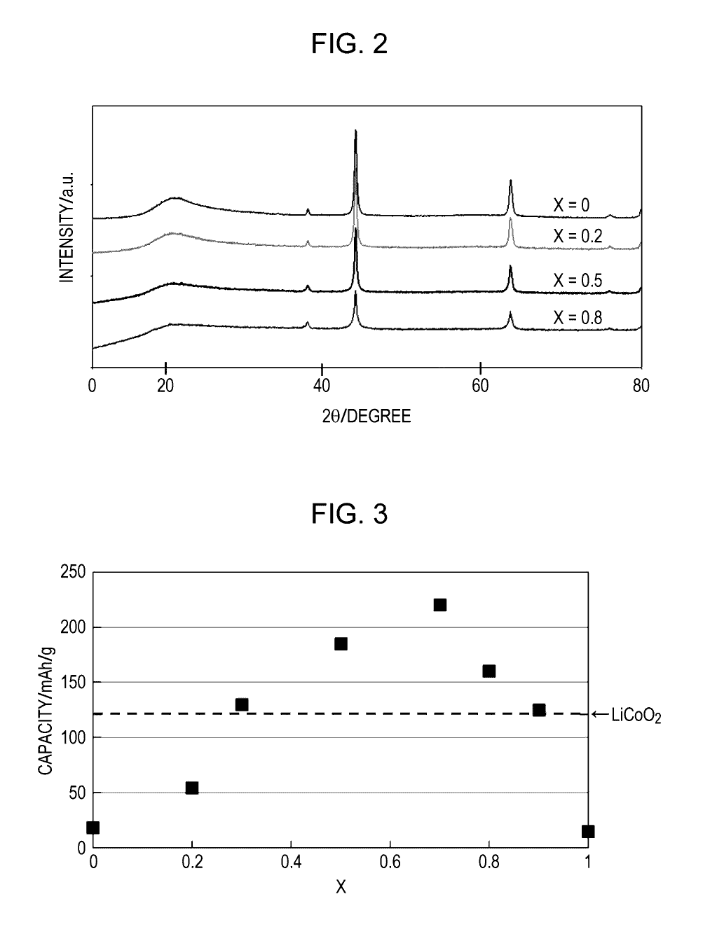

FIG. 2 is a graph showing the results of an X-ray diffraction measurement.

In FIG. 2, the results of the X-ray diffraction measurement obtained at X=0, X=0.2, X=0.5, and X=0.8 in the above formula (1) are shown.

As shown in FIG. 2, in the range in which 0)(0.8 holds, it is confirmed that a single phase can be synthesized.

Table 1 shows the initial discharge capacity of each battery. In addition, Table 1 also shows the half width of a diffraction peak of the (200) plane of each positive electrode active substance at 2θ by a powder X-ray diffraction (XRD).

TABLE 1

| | Composition of | | | |
|---|---|---|---|---|
| | Positive Electrode | | | Capacity |
| | Active Substance | X Value | Half Width | (mAh/g) |
| Example 1 | Li_{3.1}Mo_{0.7}Fe_{0.3}O_{4.1} | 0.3 | 0.369° | 130 |
| Example 2 | Li_{2.5}Mo_{0.5}Fe_{0.5}O_{3.5} | 0.5 | 0.29° | 185 |
| Example 3 | Li_{1.9}Mo_{0.3}Fe_{0.7}O_{2.9} | 0.7 | 0.369° | 220 |
| Example 4 | Li_{1.6}Mo_{0.2}Fe_{0.8}O_{2.6} | 0.8 | 0.393° | 160 |
| Example 5 | Li_{1.3}Mo_{0.1}Fe_{0.9}O_{2.3} | 0.9 | 0.395° | 125 |
| Example 6 | Li_{3.4}Mo_{0.8}Fe_{0.2}O_{4.4} | 0.2 | 0.318° | 54 |
| Comparative | Li₄MoO₅ | 0 | 0.310° | 18 |
| Example 1 | | | | |
| Comparative | LiFeO₂ | 1 | 0.329° | 15 |
| Example 2 | | | | |
| Comparative | LiCoO₂ | — | 0.250° | 120 |
| Example 3 | | | | |

As shown in Table 1, the initial discharge capacity of the battery of each of Examples 1 to 6 is larger than the initial discharge capacity of the battery of each of Comparative Examples 1 and 2.

That is, according to the batteries formed in the examples of Embodiment 1, a discharge capacity exceeding that obtained in the case in which the positive electrode active substance is only formed from Li₄MoO₅ and that obtained in the case in which the positive electrode active substance is only formed from LiFeO₂ can be obtained.

FIG. 3 is a graph showing the initial discharge capacity.

In FIG. 3, the horizontal axis indicates the X value, and the vertical axis indicates the initial discharge capacity (mAh/g).

In FIG. 3, Examples 1 to 6 and Comparative Examples 1 and 2 are shown by ▪.

As shown in FIG. 3, when X=0.7 holds, the highest capacity is obtained.

In addition, in the case in which X=0.8 holds, the capacity is decreased as compared to that in the case in which X=0.7 holds. The reason for this is believed that since no impurities are observed in the XRD measurement results shown in FIG. 2, the Li amount to be used is decreased.

In addition, in FIG. 3, the actual capacity (120 mAh/g) of the Comparative Example 3 (LiCoO₂) is shown by a dotted line.

As shown in FIG. 3, when the X value satisfies 0.3≦X≦0.9, a capacity exceeding an actual capacity of 120 mAh/g of LiCoO₂, which is a related material, can be obtained.

### Example 7

### (1) Formation of Positive Electrode Active Substance

Predetermined amounts of lithium peroxide, iron hydroxide, and molybdenum oxide were weighed in respective containers, so that a raw material mixture was obtained. That is, the respective raw materials were weighed and mixed together in accordance with the stoichiometric ratio thereof. The raw material mixture thus obtained was received in a 45-cc zirconia-made container together with an appropriate amount of zirconia-made balls each having a diameter of 3 mm and was tightly sealed in an argon glove box. After the container was recovered from the argon glove box, a treatment was performed at 500 rpm for 12 hours by a planetary ball mill. In Example 7, as the positive electrode active substance, (0.5)Li₄MoO₅-(0.5)LiFeO₂ was obtained in which the X value of (1−X)Li₄MoO₅—XLiFeO₂ was 0.5. That is, as the positive electrode active substance, Li_{2.5}Mo_{0.5}Fe_{0.5}O_{3.5} was obtained. Except that the composition ratio and the treatment method of this positive electrode material were changed, a battery of Example 7 was formed in a manner similar to that of Example 1.

### Example 8

As the positive electrode active substance, (0.3)Li₄MoO₅-(0.7)LiFeO₂ was used in which the X value of (1−X)Li₄MoO₅—XLiFeO₂ was 0.7. That is, as the positive electrode active substance, Li_{1.9}Mo_{0.3}Fe_{0.7}O_{2.9} was used. Except that the composition ratio of this positive electrode material was changed, a battery of Example 8 was formed in a manner similar to that of Example 7.

### Example 9

As the positive electrode active substance, (0.2)Li₄MoO₅-(0.8)LiFeO₂ was used in which the X value of (1−X)Li₄MoO₅—XLiFeO₂ was 0.8. That is, as the positive electrode active substance, Li_{1.6}Mo_{0.2}Fe_{0.8}O_{2.6} was used. Except that the composition ratio of this positive electrode material was changed, a battery of Example 9 was formed in a manner similar to that of Example 7.

### (Evaluation of Each Battery)

For charging, after constant current charging at a current of 0.05 CmA was performed to an upper limit voltage of 4.8 V, charging at a constant voltage of 4.8 V was further performed to a current of 0.01 CmA.

For discharging, constant current discharging at a current of 0.05 CmA was performed to a discharge cutoff voltage of 1.5 V.

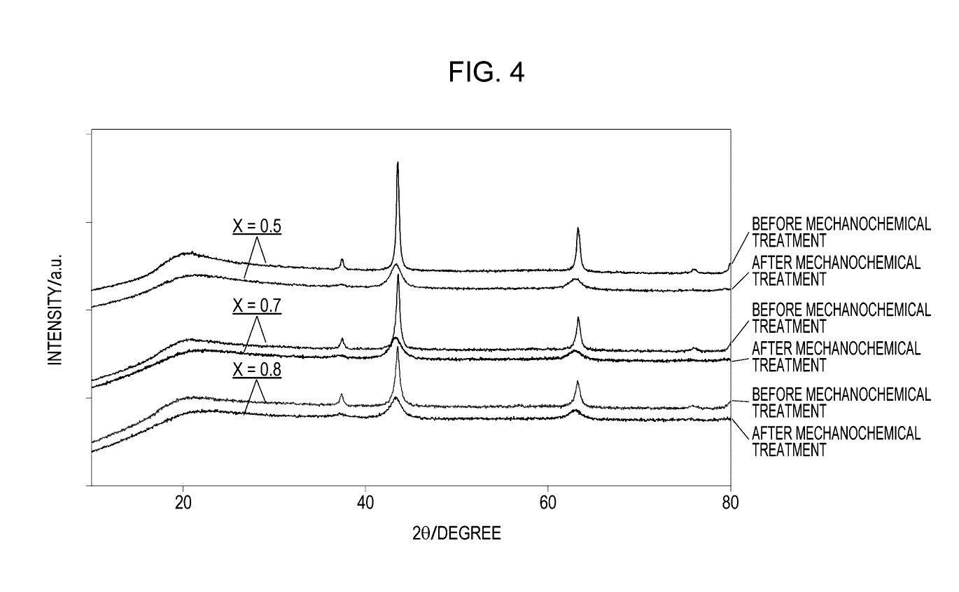

FIG. 4 is a graph showing the results of the X-ray diffraction measurement.

Table 2 shows the initial discharge capacity of each battery.

TABLE 2

| | Composition of Positive | | Half | Capacity |
|---|---|---|---|---|
| | Electrode Active Substance | X Value | Width | (mAh/g) |
| Example 7 | Li_{2.5}Mo_{0.5}Fe_{0.5}O_{3.5} | 0.5 | 1.448° | 280 |
| Example 8 | Li_{1.9}Mo_{0.3}Fe_{0.7}O_{2.9} | 0.7 | 1.546° | 300 |
| Example 9 | Li_{1.6}Mo_{0.2}Fe_{0.8}O_{2.6} | 0.8 | 1.500° | 260 |

As shown in Table 2, the initial discharge capacity of the battery of each of Examples 7 to 9 is larger than the initial discharge capacity of the battery of each of Comparative Examples 1 to 3.

In addition, as apparent from Tables 1 and 2, the initial discharge capacity of the battery of each of Examples 7 to 9 is larger than the initial discharge capacity of the battery of each of Examples 2 to 4.

As described above, according to the batteries formed in the examples of Embodiment 1, a discharge capacity exceeding that of a related material can be obtained.

The positive electrode material of the present disclosure can be used, for example, as a positive electrode material of a lithium ion battery.

What is claimed is:

1. A battery positive electrode material containing:
a positive electrode active substance represented by the following composition formula (2),
Li_{α}Mo_{β}Fe_{γ}O_{z} Formula (2)
wherein in the above formula (2),
1<α<4,
0<β<1,
0<γ<1, and
2<z<5 hold.

2. The battery positive electrode material according to claim 1,
wherein in the above formula (2),
1.3≦α≦3.1,
0.1≦β≦0.7,
0.3≦γ≦0.9, and
2.3≦z≦4.1 hold.

3. The battery positive electrode material according to claim 1,
wherein in the above formula (2), z=α+β+γ holds.

4. The battery positive electrode material according to claim 1,
wherein the half width of a diffraction peak of the (200) plane of the positive electrode active substance at 2θ by a powder X-ray diffraction (XRD) is 0.29° or more.

5. The battery positive electrode material according to claim 1,
wherein the crystal structure of the positive electrode active substance is a rock salt type.

6. A lithium ion battery comprising:
a positive electrode containing a battery positive electrode material;
a negative electrode; and
an electrolyte,
wherein the battery positive electrode material contains a positive electrode active substance represented by the following composition formula (2)
Li_{α}Mo_{β}Fe_{γ}O_{z} Formula (2), and
wherein in the above formula (2),
1<α<4,
0<β<1,
0<γ<1, and
2<z<5 hold.

7. The lithium ion battery according to claim 6, further comprising a fluorinated solvent in which the electrolyte is dissolved,
wherein the fluorinated solvent is at least one selected from the group consisting of fluoroethylene carbonate, methyl fluoropropionate, fluorobenzene, fluoroethyl methyl carbonate, and fluorodimethylene carbonate.
